(19) United States
(12) Patent Application Publication
(10) Pub. No.: US 2002/0031195 A1
(43) Pub. Date: Mar. 14, 2002

(54) Method and apparatus for constellation decoder

(76) Inventor: Hooman Honary, Newport Beach, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/949,460

(22) Filed: Sep. 7, 2001

Related U.S. Application Data
(60) Provisional application No. 60/231,726, filed on Sep. 8, 2000.
(60) Provisional application No. 60/231,521, filed on Sep. 9, 2000.

(51) Int. Cl. H04L 27/06

(52) U.S. Cl. 375/341

(57) ABSTRACT

A method and apparatus for performing a slicer and Viterbi decoding operations which are optimized for single-instruction/multiple-data type of parallel processor architectures. Some non-regular operations are eliminated and replaced with very regular repeatable tasks that can be efficiently parallelized. A first aspect of the invention provides a pre-slicer scheme where once eight input symbols for a Viterbi decoder are ascertained and their distances calculated, these distances are saved in an array. A second aspect of the invention provides a novel way of performing the path and branch metric calculations in parallel to minimize processor cycles. A third aspect of the invention provides a method to implement the Viterbi decoder without continually performing a trace back. Instead, the previous states along the maximum likelihood paths for each trellis state are stored. When the path with the shortest distance is later selected, determining the trace back state merely requires a memory access.

### CROSS REFERENCE TO RELATED APPLICATIONS

This non-provisional United States (U.S.) Patent Application claims the benefit of U.S. Provisional Application No. 60/231,726 filed on Sep. 8, 2000 by inventor Hooman Honary and titled “METHOD AND APPARATUS FOR CONSTELLATION DECODER” and is also related to U.S. Provisional Application No. 60/231,521, filed on Sep. 9, 2000 by Anurag Bist et al. having Attorney Docket No. 004419.P012Z; U.S. patent application Ser. No. ______, titled “NETWORK ECHO CANCELLER FOR INTEGRATED TELECOMMUNICATION PROCESSING”, filed on Sep. 6, 2001 by Anurag Bist et al. having Attorney Docket No. 042390.P12532; and U.S. patent application Ser. No. 09/654,333, filed on Sep. 1, 2000 by Anurag Bist et al. having Attorney Docket No. 004419.P011, entitled “INTEGRATED TELECOMMUNICATIONS PROCESSOR FOR PACKET NETWORKS”, all of which are to be assigned to Intel Corp.

### FIELD

This invention relates generally to communication devices, systems, and methods. More particularly, the invention relates to a method, apparatus, and system for optimizing the operation of a constellation and Viterbi decoder for a parallel processor architecture.

### BACKGROUND

Devices and systems for encoding and decoding data are used extensively in modern electronics and software, especially in applications involving the communication and/or storage of data.

During transmission, communications often experience interference and disruptions. This causes all or part of the data or content transmitted to become shifted, altered, or otherwise more difficult to identify at the receiving side.

Coding provides the ability of detecting and correcting errors in the data or content being processed by a system. Coding is employed to organize the data into recognizable patterns for transmission and receipt. This is accomplished by the introduction of redundancy into the data being processed by the system. Such functionality reduces the number of data errors, resulting in improved system reliability.

Coding typically comprises first encoding data to be transmitted and later decoding such encoded data. FIG. 1 illustrates a transmitting system 102 which encodes data or content to be transmitted and a receiving system 104 which decodes the received message, packet, or signal to obtain the data or content.

One common method for encoding data involves convolutional encoding. FIG. 2 illustrates the convolutional encoding of two bits into three bits with a contraint length of one (1). FIG. 3 illustrates another convolutional encoder for encoding two bits of data into three bits but with a constraint length of K.

The constraint length indicates the number of previous input clock cycles (previous input frames) necessary to generate one output frame. Theoretically, a longer constraint length provides a more robust encoding scheme since the probability of erroneously decoding a particular packet is diminished due to its dependence on prior received packets.

Before encoded data is transmitted, it is typically mapped into a signal constellation. A signal constellation permits encoded bit segments to be mapped to a particular symbol. Each symbol may correspond to a unique phase and/or magnitude and may be represented in terms of coordinates (I,Q) in the constellation. Thus, an encoded bit stream may be mapped into a sinusoidal signal for transmission according to such phase and/or magnitude.

FIG. 4 illustrates a quadrature amplitude modulation (QAM) constellation of one hundred twenty-eight (128) symbols.

At the receiving side, a device must be able to first convert the sinusoidal signal received into a bit stream and then decode the bit stream to extract the content or data. That is, each received signal sample is first converted into a symbol in the constellation. The selection of a corresponding symbol in the constellation for each received sample is known as slicing. Then the symbol is decoded to obtain the data or content.

Typically, a receiving device samples the received signal, determines the phase and/or magnitude of each sample, and maps each sample into a constellation according to its phase and/or magnitude. However, due to interference or other disruption during transmission, a sample may fall in between defined constellation symbols. Even if the received sample corresponds to an exact symbol in the constellation, there is no guarantee that the received sample has not shifted or otherwise been mismatched with a constellation symbol. However, an appropriate coding scheme serves to correctly identify a received sample.

In the conventional art, the Viterbi decoder or the Viterbi decoding algorithm is widely used as a method for compensating for transmission errors in digital communication systems.

The Viterbi decoder relies on finding the maximum likelihood path along a trellis. A trellis diagram for one-to-three (1/3) bit encoding is illustrated in FIG. 5. The object of the Viterbi algorithm is to find the fewest number of possible steps, shortest distance metric, outgoing from the all-zero state S₀, and returning to the all-zero state S₀ for any given trellis.

The Viterbi decoder performs maximum likelihood decoding by calculating a measure of similarity or distance between the received signal and all the code trellis paths entering each state. The Viterbi algorithm removes trellis paths that are not likely to be candidates for the maximum likelihood choices.

Therefore, the Viterbi algorithm aims to choose the code word with the maximum likelihood metric. Stated another way, a code word with the minimum distance metric is chosen. The computation involves accumulating the branch metrics along a path.

However, implementing a Viterbi decoder is quite complex. For instance, the dependence in the phase and quadrature of the transmitted symbols leads to a requirement that the Viterbi decoder compute a large number of “metrics”, each of which are measures of the distance squared (Euclidean distances) between the received sample point and every point in the signal constellation. This computation can be quite time consuming degrading the performance of a processor.

Another drawback of implementing Viterbi decoder is that as the number of branches in the trellis diagram increases (such as when more bits are convolutionally encoded in each frame) more branches merge into each state. As a result, a larger number of comparisons are required in calculating and selecting the minimum distance path for each state of a Viterbi decoder.

However, implementing the Viterbi algorithm requires many distance calculations, slowing the processor and/or consuming a significant amount of memory.

### BRIEF DESCRIPTIONS OF THE DRAWINGS

FIG. 1 is a block diagram illustrating a communication system where the constellation decoder of the invention may be employed.

FIG. 2 is an exemplary block diagram illustrating the operation of a rate two-three (2/3), constraint-length one (1) convolutional encoder.

FIG. 3 is another exemplary block diagram illustrating the operation of a rate two-three (2/3), constraint-length K convolutional encoder.

FIG. 4 is an exemplary constellation diagram illustrating a quadrature amplitude modulation (QAM) constellation of one hundred twenty-eight (128) symbols.

FIG. 5 is an exemplary trellis diagram of coding rate one-three (1/3) and constraint-length five (5).

FIG. 6 illustrates pseudo code for an exemplary conventional algorithm for calculating branch metrics of a Viterbi decoder.

FIG. 7 illustrates pseudo code for an exemplary algorithm for calculating branch metrics of a Viterbi decoder according to the present invention.

FIG. 8 illustrates a trellis diagram for which branch distances may be calculated in parallel according to one implementation of the parallel processing algorithm of the invention.

FIG. 9 illustrates an array configured to provide a set of four parallel processors the previous trellis states for calculating the branch distances to a new trellis state.

FIG. 10 illustrates one embodiment of a parallel processing device configured to perform parallel branch calculations according to the invention.

FIG. 11 illustrates another embodiment of the parallel processor system in FIG. 10 where each processor is capable of performing multiple branch calculations in parallel.

FIG. 12 illustrates one embodiment of a set of arrays that stores previous states symbols for each maximum likelihood path of a trellis to bypass the trace-back process according to the invention.

FIG. 13 illustrates one embodiment of the one array in FIG. 12, showing how the previous state symbols may be represented as three-bit number for an eight state trellis.

FIG. 14 is a flow diagram illustrating an exemplary conventional method for performing Viterbi decoding.

FIG. 15 is a flow diagram illustrating an exemplary method for performing Viterbi decoding according to one embodiment of the present invention.

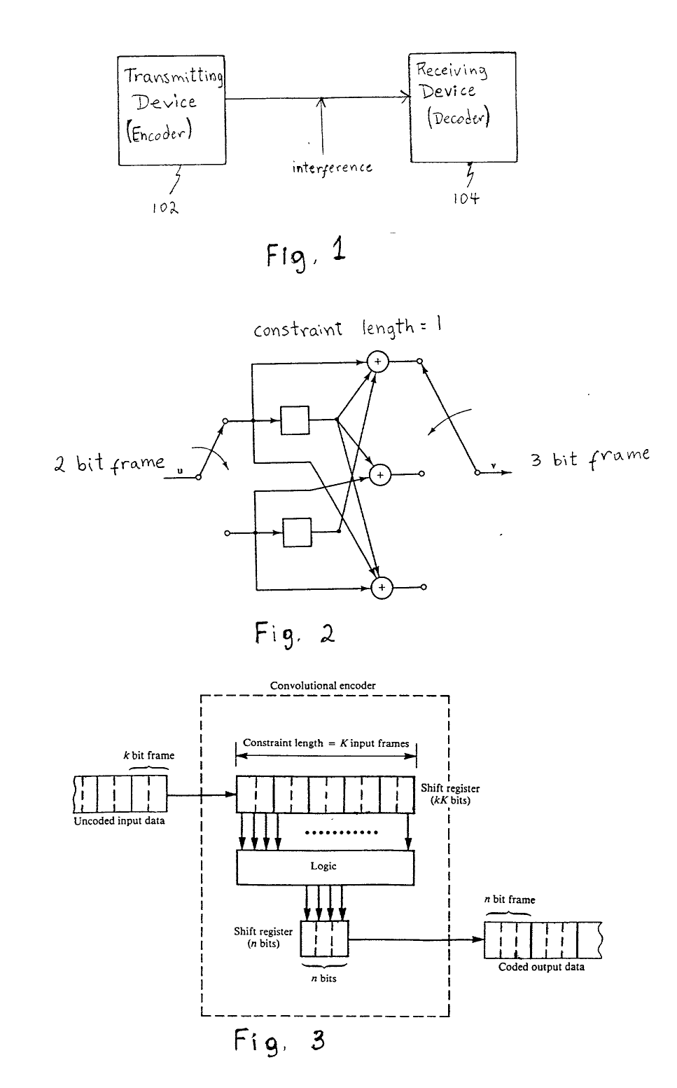

### DETAILED DESCRIPTION

In the following detailed description of the invention, numerous specific details are set forth in order to provide a thorough understanding of the invention. However, it is contemplated that the invention may be practiced without these specific details. In other instances well known methods, procedures, components, and circuits have not been described in detail so as not to unnecessarily obscure aspects of the invention.

It is understood that the invention applies to communications devices such as transmitters, receivers, transceivers, modems, and other devices employing a constellation and/or Viterbi decoder in any form including software and/or hardware.

The invention provides a novel system for performing slicer and Viterbi decoder operations which are optimized for single-instruction multiple-data stream (SIMD) type of parallel processor.

For purposes of illustration, the description below relies on a rate two-three (2/3) 2D eight (8) state code such as that defined in V.32bis and employed in Consumer Digital Subcriber Line (CDSL) services. However, it must be clearly understood that the invention is not limited to any particular code rate or communication standard and may be employed with other code rates and communication standards.

Initializing a typical Viterbi decoder requires that a number of constellation symbol distances be provided as inputs to the decoder. For example, in a rate two-three (2/3) code (two (2) input bits are convolutionally encoded into three (3) output bits) eight (8) distances must be provided to initialize the Viterbi decoder. Each distance must correspond to a constellation symbol representing a unique three (3) bit combination so that each of the possible combinations of coded bits is represented (i.e. 000, 001, 010, 011, 100, 101, 110, 111).

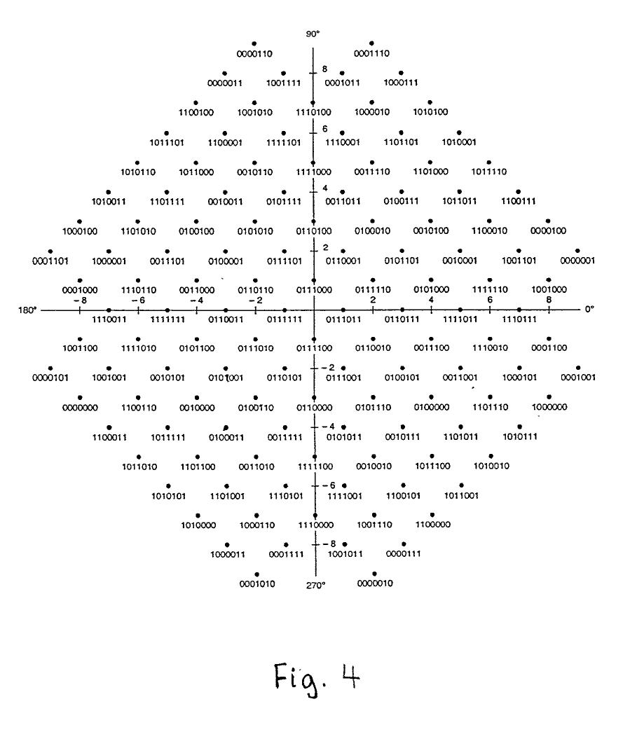

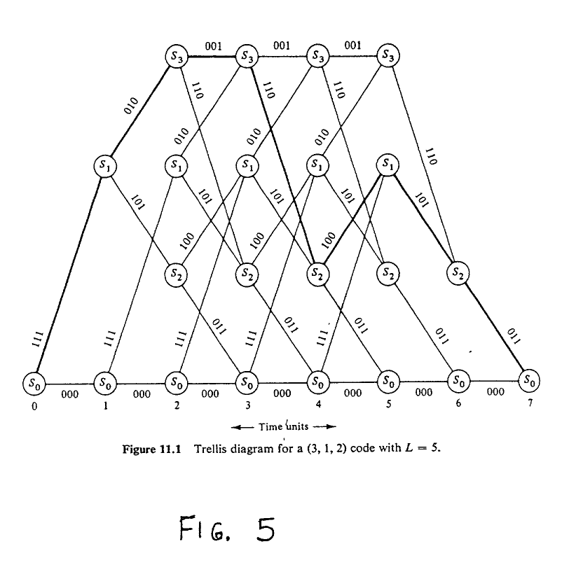

In the QAM-128 constellation (illustrated in FIG. 4), each symbol or point corresponds to seven (7) bits. Thus, each possible three (3) bit combination corresponds to any of sixteen (16) symbols in the constellation. That is, if only the lower three (3) bits of each seven (7) bit constellation symbol are considered, sixteen (16) of the one hundred twenty-eight (128) constellation symbols will have the same lower three (3) bits. Each set of symbols containing the same mapped bits (i.e., the three (3) lower bits in this instance) are known as cosets.

Typically, the eight (8) symbols which are closest to the received sample are employed as inputs to the Viterbi decoder. However, this usually requires that the distance between every constellation symbol and the received sample be calculated. Then the smallest distance corresponding to each of the possible three (3) bit combinations is selected as the input to the Viterbi decoder. Once the Viterbi decoder determines the best symbol match, a slicer operation is performed to obtain the distance of the selected symbol.

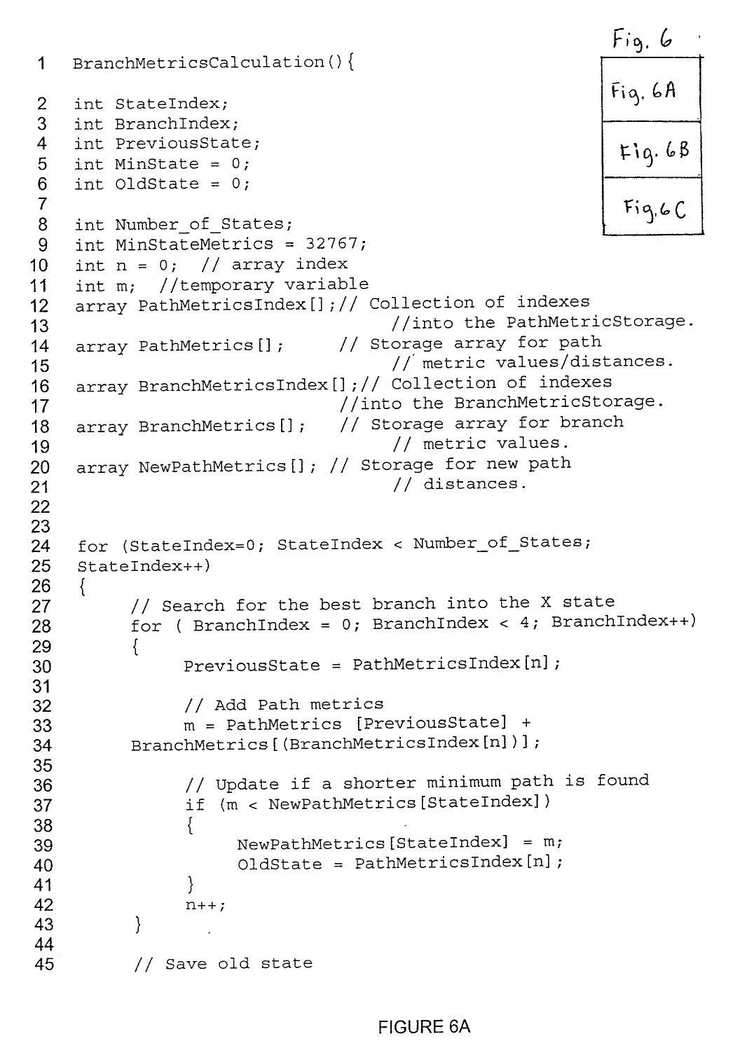

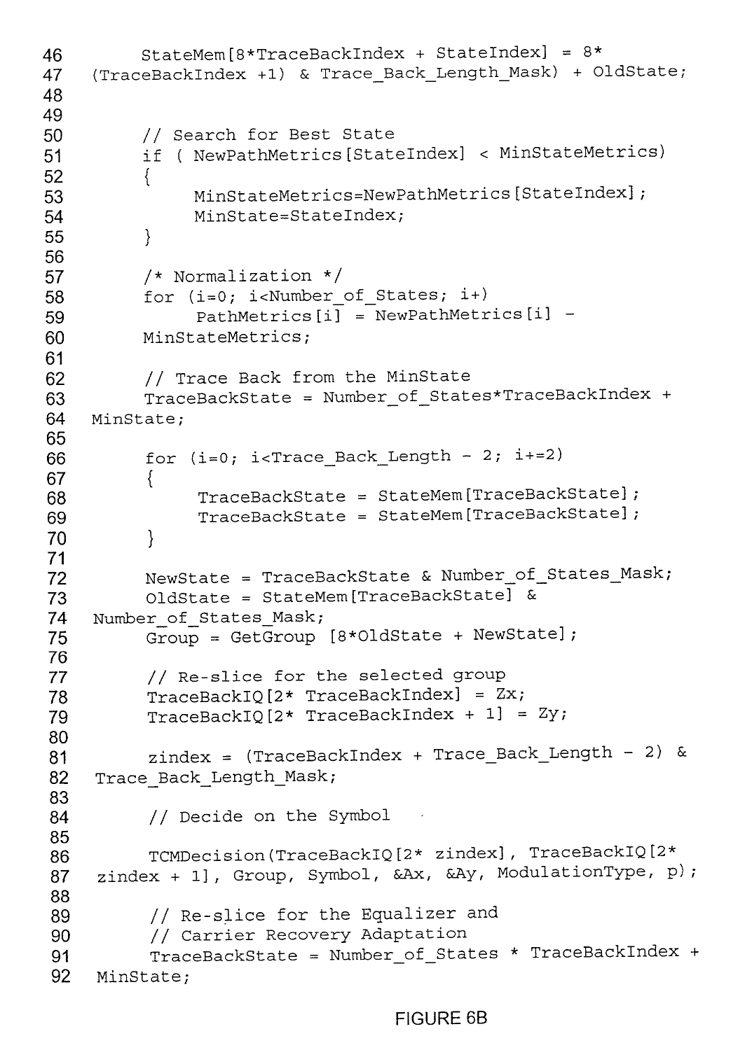

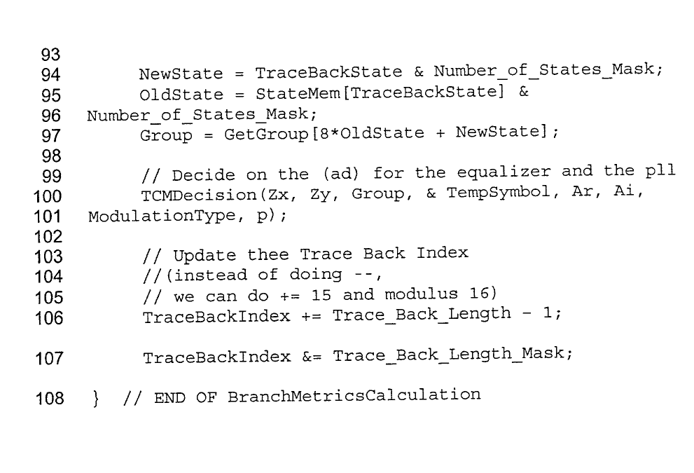

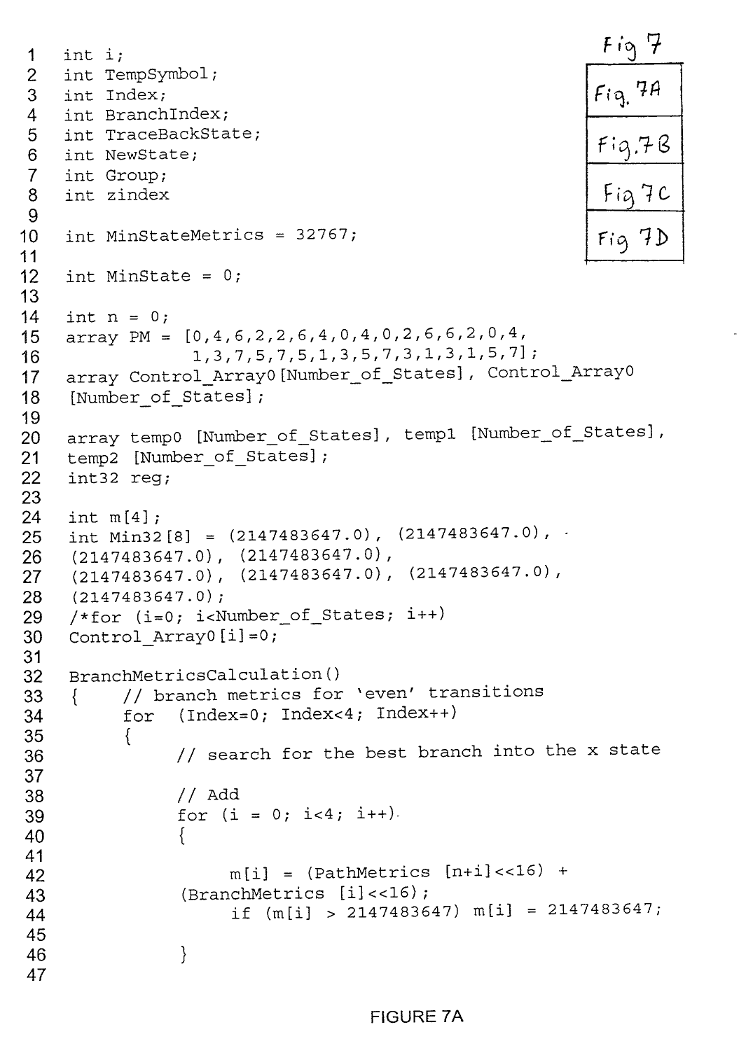

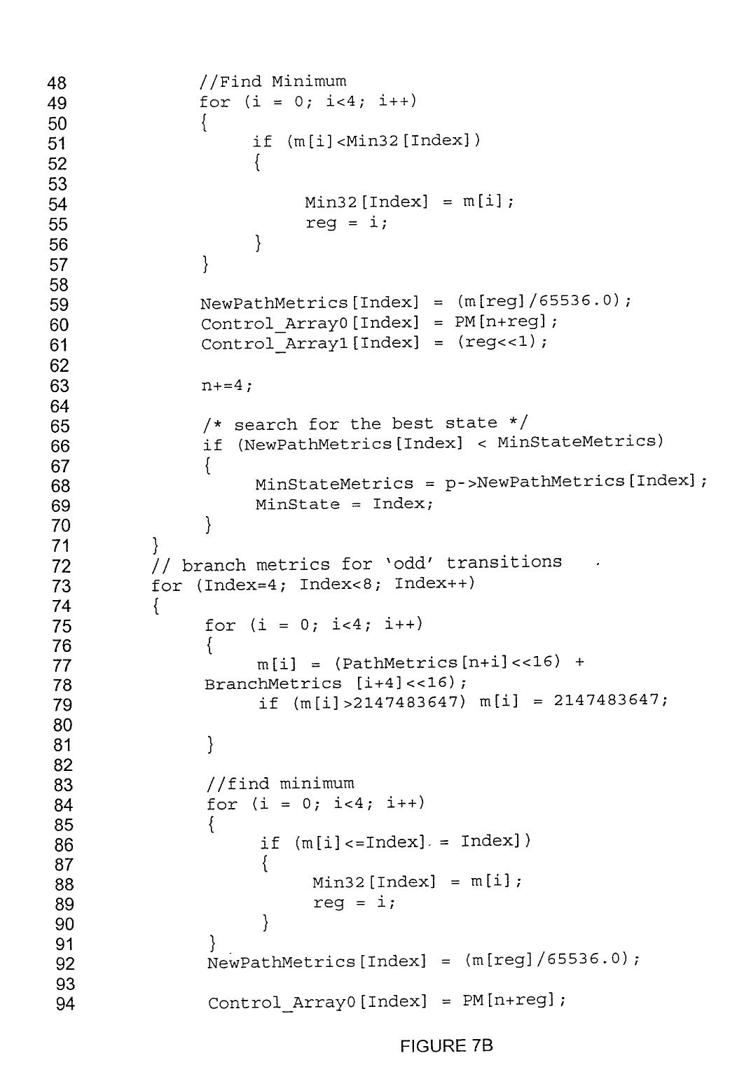

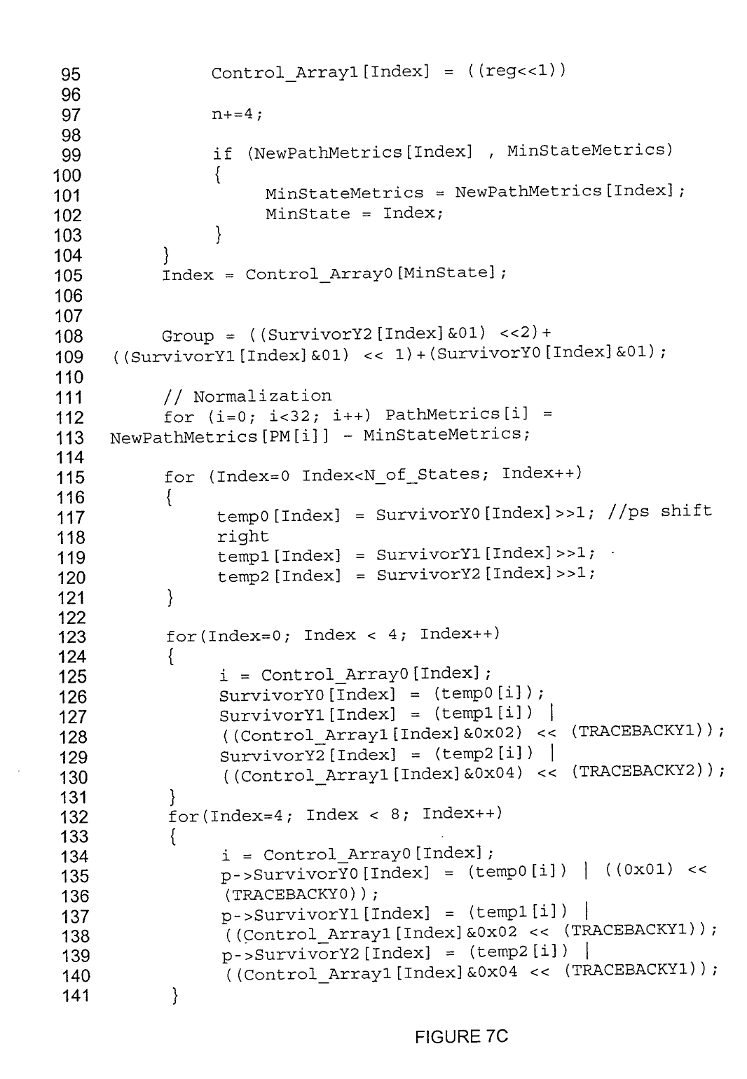

FIGS. 6 and 7 illustrates pseudo code for an exemplary convention Viterbi decoder algorithm (FIG. 6) and an exemplary Viterbi decoder according to the present invention (FIG. 7). These two figures illustrate the differences between the prior art and the present invention for decoding a QAM-128 constellation and a rate two-three (2/3) code as describe above. Note that all or part of the code shown in FIGS. 6 and 7 may be implemented in hardware and/or firmware. A person of ordinary skill in the art would recognize that some of the calculations/steps performed by the conventional algorithm in FIG. 6, such as recursive loops, are very difficult to implement in hardware. Various aspects of the invention seek to provide more efficient ways for performing Viterbi decoding on a processor or in hardware.

A first aspect of the invention provides a pre-slicer scheme where once the eight input symbols are ascertained and their distances calculated, these distances are saved in an array. When the best matching symbol is later determined, the slicing operation merely requires an array access (FIG. 7, lines 150-155). While this approach uses more memory, it obviates the need for a separate slicer and greatly reduces the over all MIPS requirements of the operation.

Once the eight inputs are provided to the Viterbi decoder, for each state of the trellis the decoder must first calculate the distance metrics for each possible branch and then calculate the minimum path distance from the new state to the zero state. This latter process is known as tracing back; the decoder starts with the last-in-time state and traces back to the first-in-time state to determine the maximum likelihood path (minimum distance path) along the trellis.

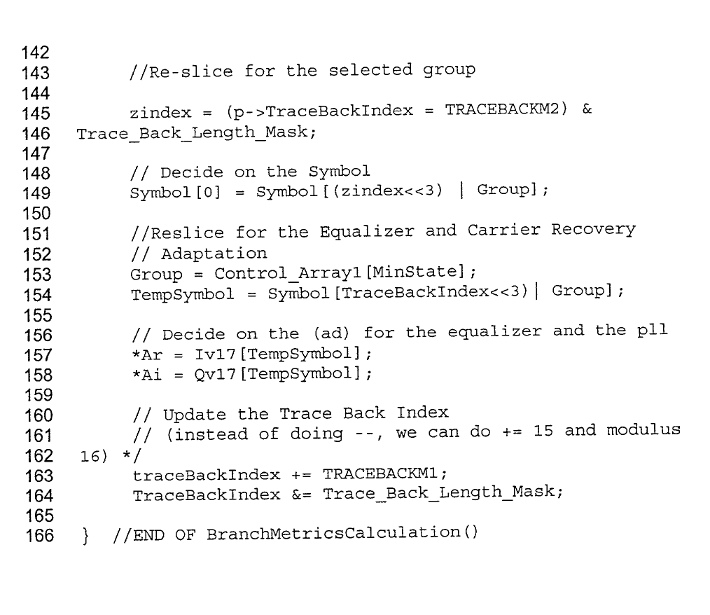

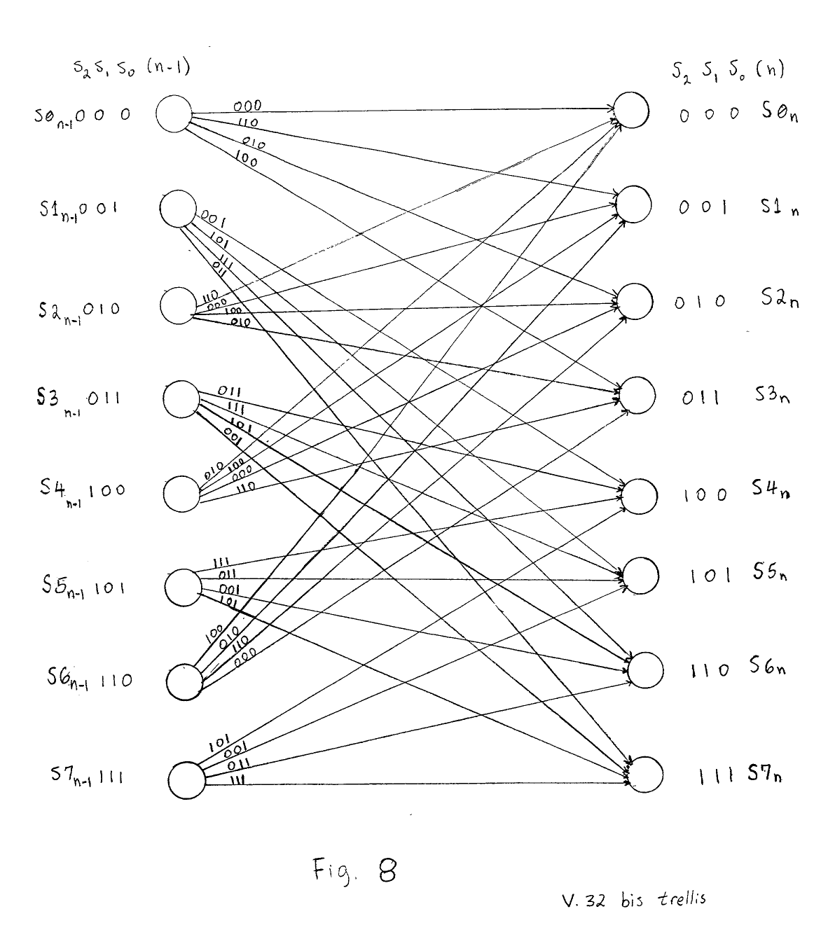

The conventional method of calculating branch metrics for each state of a trellis is computationally inefficient. Referring to FIG. 8 a conventional eight-state trellis (i.e., as defined in various International Telecommunication Union (ITU) and Consultive Committee for International Telephone and Telegraph (CCITT) V.32 and V.32 bis standards) ‘n’ states deep is shown. For each new state (i.e., S0n through S7n) branch metrics must be calculated for every possible transition from the previous states (i.e., S0n-1 through S7n-1). For the example illustrated in FIG. 8, four branch metrics must be calculated for each new state S0n through S7n. Calculation of these metrics typically requires recursive loops of add, compare, and select operations.

As illustrated in FIG. 6, lines 24-44, the conventional method of calculating such metrics requires recursive loops (FIG. 6, line 28) and multiple indexing (FIG. 6, lines 33-34). This conventional method employs a sequential Viterbi algorithm to calculate the branch metric, for each possible state or symbol and update the metrics for the minimum distance path. The typical branch metric calculation (FIG. 6, lines 33-34) requires accessing an index in memory (BranchMetricsIndex[n]) corresponding to a trellis state. This index is then employed to access a second memory location (BranchMetrics[]) containing information for the corresponding branch. This method consumes a significant number of micro-instructions per second (MIPS) due to its sequential structure. Therefore, these operations are time-consuming, inefficient, and difficult to implement in hardware.

A second aspect of the invention provides a novel way of performing the branch metric calculations described above by employing parallel processing systems. Instead of sequentially calculating the four metrics for each of the new states S0n through S7n, the invention provides a way to perform these calculations in parallel.

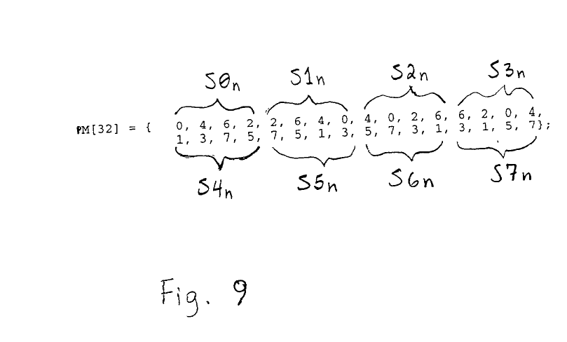

For the exemplary trellis shown in FIG. 8, an array (shown in FIG. 9) is defined which specifies the possible previous states (S0n-1 through S7n-1) for each new state (S0n through S7n). In this example, states S0n, S1n, S2n, and S3n have ‘even’ branch transitions 0, 2, 4, and 6 which originate from ‘even’ previous states S0n-1, S2n-1, S4n-1, and S6n-1. Similarly, states S4n, S5n, S6n, and S7n have ‘odd’ branch transitions 1, 3, 5, and 7 which originate from ‘odd’ previous states S1n-1, S3n-1, S5n-1, and S7n-1. Arranging the array between even and odd transitions permits vectorizing the metrics calculations. Additionally, the transitions (i.e., 0,4,6,2 for S0n) are arranged from lowest to highest transition values. For example, for new state S0n the ‘000’ branch transition is to previous state S0n-1, the next highest branch transition ‘010’ is to S4n-1, followed by branch transition ‘100’ to S6n-1, and lastly branch transition ‘110’ is to S2n-1. The order of these elements for each state (i.e., S0n: 0,4,6,2) permits the system to identify the previous state symbol based on the order of these elements. That is, since each combination of elements is unique within the array, the order of the elements identifies the previous states from which the transitions originate. This array may be generated and stored for later use by the processing system so that each parallel processor knows which branch to calculate for a given state.

The array in FIG. 9 is employed by parallel processors to calculate the branch metrics for new states in one operation. For instance, the metrics or distances for new state S0n to its possible previous states, S0n-1, S2n-1, S4n-1, and S6n-1, may be calculated in a single instruction using parallel processors. This avoids the looping and indexing of the conventional method described above.

FIG. 10 illustrates a system 1002 of parallel processors 1004 (Processors A, B, C, . . . L) which may be employed in one embodiment of the invention. In one implementation, the processors 1004 are configured to perform parallel calculations of branch metrics or distances for a new state using the specified array. That is, each of the parallel processors 1004 calculates the branch distance for one transition of the new state. For example, referring to FIGS. 8 and 9, for state S5n a first processor calculates 10 the branch distance to state S7n-1, a second processor calculates the branch distance to state S5n-1, a third processor calculates the branch distance to state Sln-1, and a fourth processor calculates the branch distance to state S3n-1. The first, second, third, and fourth processors calculating the branch distances in parallel or concurrently.

According to another embodiment, shown in FIG. 11, each processor 1004 may have a plurality of multipliers/accumulators 1006 to perform a plurality of parallel calculations. Thus, a single processor 1004 may perform the parallel calculations for branch distances of a new state (i.e., S3n in FIG. 8). For example, four multipliers/accumulators 1006 would permit a processor 1004 to perform the branch distance calculations for all four transitions into one new state as described above.

An exemplary embodiment of this algorithm is shown in FIG. 7 (lines 35-105). As noted above, this aspect of the invention restructures the Viterbi algorithm to simplify its implementation on parallel processors and exploit the benefits of parallel processing. The distance/metrics calculations (add-compare-select operations) performed by the Viterbi algorithm are divided into two loops. The first loop (FIG. 7, lines 40-73) performs calculations for the ‘even’ transitions from previous states, and the second loop (FIG. 7, lines 74-105) performs calculations for the odd transitions from previous states.

According to one embodiment which may be implemented in a single-instruction multiple-data (SIMD) processor, four add operations, four compare operations, and four select operations are performed in each instruction. Thus, the steps in FIG. 7, lines 35-58 for calculating the even transition distances may be performed in a single instruction. Likewise, the steps in FIG. 7, lines 76-92 for calculating the odd transition distances may be performed in a single instruction.

In order to enable the parallel processing of the add-compare-select operations, the path and branch metrics for each state are saved in an expanded and non-irregular array. The branch distances for each new state are temporarily stored (i.e., FIG. 7 lines 40-58, ‘m[i]’) to facilitate obtaining the minimum distance branch. The path metrics for the even and odd states are stored in an array to facilitate subsequent updates to these state metrics. The overall maximum likelihood path distance for each state is stored in an array (i.e., FIG. 7 lines 113-114, ‘PathMetrics[i]’) as well as the previous state symbols for each path (i.e. FIG. 7 lines 116-142, ‘SurvivorY0’, ‘SurvivorY1’, and ‘SurvivorY2’). Storing these values removes any requirement for shuffling or multiple indexing in the inner loops.

For each new state the best metric or shortest distance to the previous state is selected and saved (i.e., FIG. 7, lines 50-58). Once the best branch distance metrics have been selected for all new states, the best new state is select based on the shortest overall path distance (FIG. 7, lines 68-72).

In conventional implementations of the Viterbi decoder, the process of calculating the shortest overall path (known as tracing back) is typically very time consuming and processor intensive. Ordinarily, every time a new sample point is received a branch distance is compute for each trellis state and the shortest branch distance for each new state is selected. These distances are then used to update the cumulative metrics for the maximum likelihood path for each trellis state (FIG. 6, lines 57-107). The shortest path distance is then selected as the desired path. A trace back must be performed to determine the nth previous state in the selected path. The nth previous state corresponds to the desired state in a trellis ‘n’ states deep.

Typically, conventional implementations of the Viterbi algorithm save the branch transitions along each path. These transitions are then employed to determine each state along a path until the desired nth state is reached. As noted above, this type of trace back is processor intensive.

A third aspect of the invention provides a method to implement the Viterbi decoder without continually performing a trace back. Rather than performing a trace back and saving the transitions along a path, the previous state symbols (‘survivors’) along the path are stored instead (FIG. 7 lines 116-142). Once a minimum distance path is selected from among all stored path distances, the desired nth previous state can be recalled from storage. In this manner, the process of trace back is avoided by a simple memory access to recall the desired nth previous state.

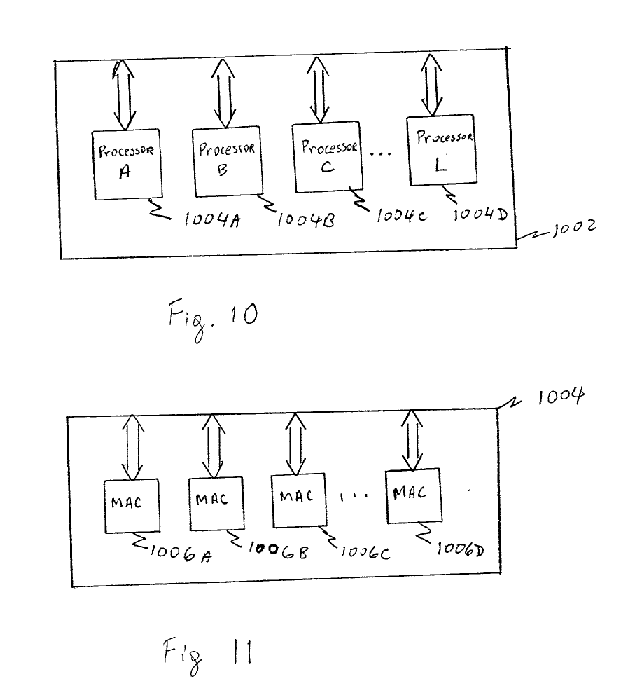

Referring to FIG. 12, exemplary storage arrays of the sixteen previous trellis states along the eight maximum likelihood paths (Y0 through Y7) are shown. For each path, the ‘n’ previous states symbols (X0n, X0n-1, . . . etc.) corresponding to the shortest branch distance are stored. Each of the eight paths Y0 through Y7 may correspond to a state S0n through S7n in FIG. 8.

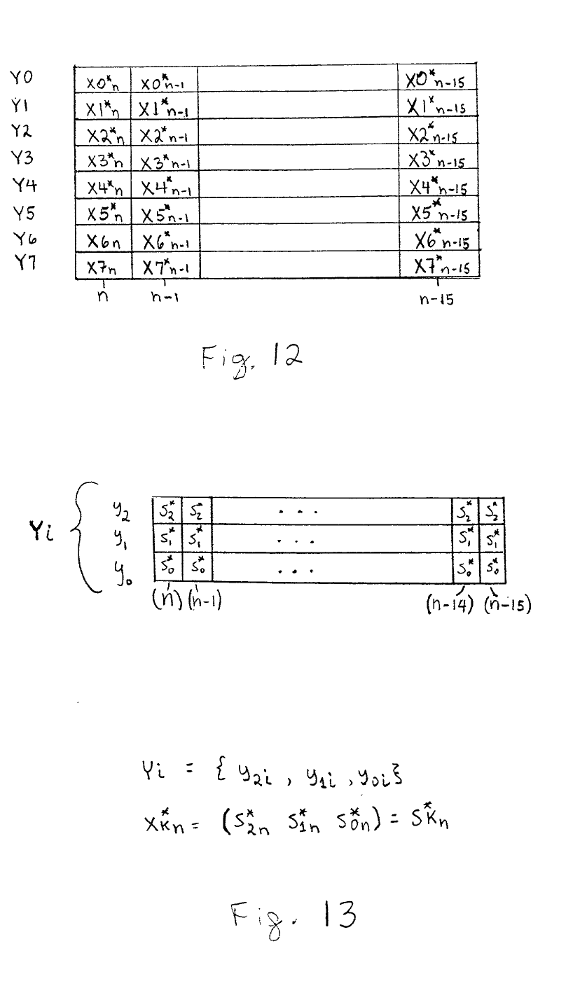

FIG. 13 illustrates how, in one embodiment, each array in FIG. 12 may be configured. Each saved previous state is represented by three bits (y2, y1, and y0). Thus, for any given previous period, three bits (s2, s1, s0) represent the bits corresponding to the state with the shortest branch metric. Note that the overall path length/distance for each path, Y0 through Y7, is also stored in a separate array. This permits readily calculating the best path with a few simple memory accesses.

For the QAM-128 constellation and rate two-three (2/3) code illustrated above, eight (8) inputs are provided for the Viterbi decoder. Since the depth of the trace back is sixteen (16), sixteen (16) three-bit words (FIG. 12 s2, s1, s0) are saved for each of the eight (8) states. This operation corresponds to copying only eight (8) three-bit words. Therefore, at any given time the bits for each state are known for the previous sixteen (16) clock cycles (previous states) without any trace-back.

Although this method increases the total number of reads and writes, because these are very regular sequential memory accesses, and because the need for the irregular operation of trace-back has been bypassed, this approach results in an overall savings of clock cycles. The additional memory requirements incurred by this method are negligible. In general, if the number of states is Ns and the trace-back depth is Lt, with the method disclosed herein the number of memory accesses is proportional to Ns×Lt bits. With the conventional trace back method the number of memory accesses is proportional to Ns+Lt. For typical values of Ns (i.e., eight states) and Lt (i.e., depth of sixteen), the method disclosed herein will be better.

A person of ordinary skill in the art would recognize that this aspect of the invention may be applied to trellises of various number of states and of different depths. The arrays for storing the previous state symbols merely need to be configured to accommodate the necessary number of bits representing a particular state symbol and the number of elements corresponding to the desired trace depth.

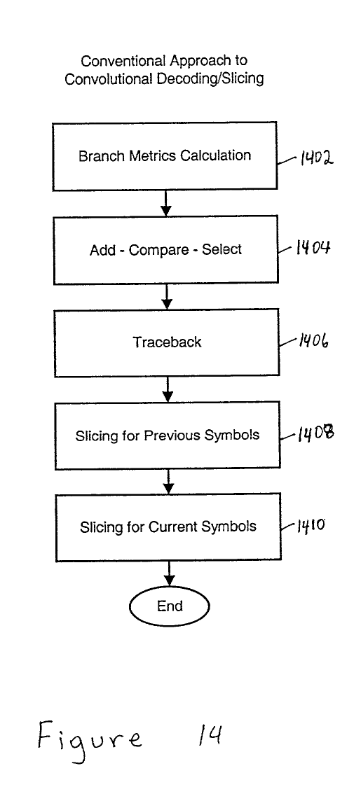

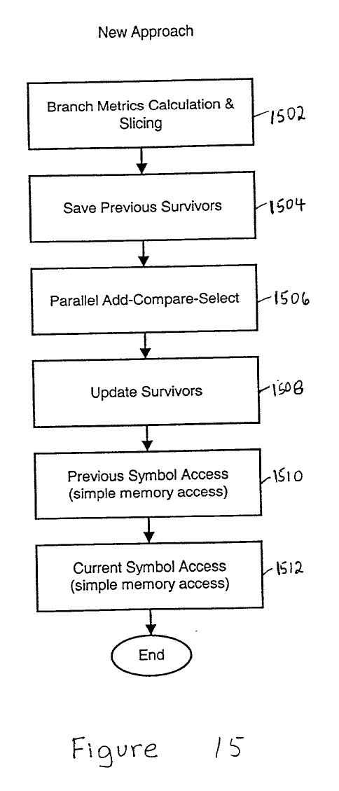

FIGS. 14 and 15 illustrate an exemplary conventional method (FIG. 14) and one embodiment of the disclosed method (FIG. 15) for performing Viterbi decoding.

According to the conventional implementation of a Viterbi decoder illustrated in FIG. 14, branch metrics are calculated 1402 as detailed above, then add, compare, and select operations are performed 1404 to determine the best metrics for each branch. A recursive trace-back is performed to calculate the shortest path for each state 1406. Lastly, slicing is performed for the previous symbols 1408 and then for the current symbols 1410.

In contrast to the conventional method illustrated in FIG. 14, the invention described herein may be performed as illustrated in FIG. 15. Branch metric calculations and slicing are performed 1502 as detailed above. Then the previous shortest paths for each state (the survivors) are stored 1504. For every new sample symbol received, newly shortest paths (survivors) are added, compared, and selected 1506 in parallel. The shortest paths (survivors) are then compared to the previous shortest paths and the survivors (shortest of the two) are updated 1508. Lastly, simple memory accesses are performed on the previously stored symbols for the previous symbols 1510 and then for the current symbols 1512 to obtain the best symbol.

A person of ordinary skill in the art will recognize that the invention has broader application than the constellation and code rate examples described above.

For instance, in another embodiment the invention may be applied to decoding communications based on the Asymmetrical Digital Subscriber Line (ADSL) Specification T1E1.4. In this example, the constellation symbols are divided into four (4) 2D cosets. Under ADSL, two received sample points are needed to perform the constellation decoding. For each pair, the closest Euclidean distance in each of the four (4) 2D cosets is found as was described above. That is, the four closest constellation points are selected for each sample point. Two sets of four symbol distances each, each set corresponding to a sample point are obtained. Cross permutations of the two sets of distances are then calculated according to the ADSL Specification T1E1.4, Table 12. Thus, a total of sixteen (16) distances are obtained. These cross permutation distances (which are 4D distances) are calculated by adding the two 2D distances. This is possible because the square root operation for the Euclidean distance is never calculated, so the powers of two can be just added together.

According to one implementation, the Viterbi decoder is a rate 2/3 code. So it has eight (8) possible transitions and it requires eight (8) distances per transition for each one of the eight (8) 4D cosets in ADSL Specification T1E1.4, Table 12. This is achieved by choosing the smallest distance between the two distances available for each 4D coset. All the bits between these two choices are completely inverted, so the possibility of making a mistake between these two should be very low. By making this decision, the fourth lowest bit is decided without any memory. In order to decide on the three lowest bits the Viterbi algorithm described above is implemented.

As a person of ordinary skill in the art will recognize, the invention described above can be readily practiced on this V.34, ADSL decoding scheme. This time the trace-back depth will be bigger, and the trellis will have sixteen (16) states. But the overall structure is very similar to the V.32bis decoder because it is a 2/3 convolutional code, and the transitions from previous states are divided into odd and even for each set of four (4) consecutive new states. In this instance, instead of two loops in the add-compare-select section, there will be will be four (4) loops.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art. Additionally, it is possible to implement the present invention or some of its features in hardware, programmable devices, firmware, integrated circuits, software or a combination thereof where the software is provided in a processor readable storage medium such as a magnetic, optical, or semiconductor storage medium.

What is claimed is:

1. A method for decoding an encoded signal comprising:
performing one or more parallel branch metric calculations to obtain the shortest branch distance to a new trellis state from the previous trellis states;
storing the previous trellis state symbol corresponding to the shortest branch metric for each new trellis state;
selecting the new state with the shortest overall path distance; and
recalling the nth previous state symbol along the selected shortest distance path.

2. The method of claim 1 further comprising:
receiving an encoded signal; and
sampling the encoded signal to obtain symbol samples of the encoded signal.

3. The method of claim 2 further comprising:
selecting the closest constellation symbols for each symbol sample received; and
storing the selected constellation symbols in a first memory location.

4. The method of claim 1 further comprising:
storing the overall maximum likelihood path distances for each state in the trellis; and
performing new parallel branch metric calculations when subsequent symbol samples are received.

5. The method of claim 1 further comprising:
calculating the shortest overall path distance for each new state including,
adding the shortest branch metric for each new trellis state to the stored maximum likelihood path distance for the selected previous trellis state, and
updating the stored maximum likelihood path distances based on the new branch metric calculations.

6. The method of claim 1 wherein storing the previous trellis state symbol includes storing a value identifying the previous trellis state symbol in an array for each state.

7. The method of claim 6 further comprising:
removing the earliest state stored in the array every time a previous trellis state is selected as having the shortest branch distance; and
inserting the selected previous trellis state in the array.

8. The method of claim 1 wherein the nth previous state symbol is the desired depth of a trace back.

9. The method of claim 1 further comprising:
accessing a memory location to obtain the current symbol corresponding to the best match for the received symbol sample.

10. The method of claim 1 wherein the branch metrics calculations are performed according to a Viterbi decoding scheme.

11. The method of claim 1 wherein the decoded symbols correspond to a quadrature amplitude modulation (QAM) constellation.

12. The method of claim 11 wherein the QAM constellation has of one hundred twenty eight (128) symbols.

13. The method of claim 1 wherein the encoded signal is encoded with a rate two-three (2/3) code.

14. A communication device comprising:
a receiving circuit to receive an encoded signal and provide symbol samples of the received signal;
a constellation processor coupled to the receiving circuit to select the constellation symbols closest to each received symbol sample; and
one or more parallel processors communicatively coupled to the constellation processor and configured to calculate the branch metrics for each new trellis state in a single instruction.

15. The communication device of claim 14 further comprising:
a storage device coupled the parallel processors to store an array of previous trellis states corresponding to each new trellis state, array is employed by the parallel processors to calculate the branch metrics for each new state at the same time.

16. The communication device of claim 15 wherein the storage device is configured to maintain list of previous trellis state symbols corresponding to the maximum likelihood path for each trellis state.

17. The communication device of claim 14 wherein the parallel processors perform new metric calculations when subsequent symbol samples are received, select the shortest distance branch metric for each new state, and update stored maximum likelihood path distances based on the new branch metric calculations.

18. The communication device of claim 14 wherein the parallel processors calculate the branch metrics according to a Viterbi decoding scheme.

19. The communication device of claim 14 wherein the parallel processors are single-instruction multiple-data stream (SIMD) type of parallel processors.

20. The communication device of claim 14 wherein the constellation processor decodes symbols according to a quadrature amplitude modulation (QAM) constellation.

21. The communication device of claim 20 wherein the QAM constellation has of one hundred twenty eight (128) symbols.

22. The communication device of claim 14 the wherein the constellation processor selects the eight (8) closest constellation symbols for a 2D trellis constellation.

23. The communication device of claim 14 wherein the constellation processor selects the four (4) closest constellation symbols for a 4D trellis constellation.

24. A system for decoding a coded signal comprising:
means for receiving an encoded signal and providing symbol samples of the encoded signal;
means for selecting symbols in a constellation which are closest to each received symbol sample; and
means for calculating the branch metrics for each branch of a trellis in parallel, storing the maximum likelihood path distance for each state, and storing the previous trellis state symbols along each path.

25. The system of claim 24 further comprising:
means for sampling the encoded signal to obtain symbol samples of the encoded signal; and
means for storing the selected constellation symbols.

26. The system of claim 24 further comprising:
means for updating the stored maximum likelihood path distances based on the new branch metric calculations.
